(19) United States
(12) Patent Application Publication
(10) Pub. No.: US 2010/0220331 A1
(43) Pub. Date: Sep. 2, 2010

(54) Micro-electromechanical system fabry-perot filter cavity

(76) Inventors: Anis Zribi, Rexford, NY (US); Glenn S. Claydon, Wynantskill, NY (US); David C. Hays, Niskayuna, NY (US); Stacey Kennerly, Niskayuna, NY (US); Long Que, Rexford, NY (US); Shankar Chandrasekaran, Chennai (IN); Shivappa Goravar, Laxmeshwar (IN); Ayan Banerjee, Bangalore (IN)

Correspondence Address: GENERAL ELECTRIC COMPANY;GLOBAL RESEARCH, ONE RESEARCH CIRCLE, BLDG. K1-3A59, NISKAYUNA, NY, 12309, US

(21) Appl. No.: 11/447,779

(22) Filed: Jun. 6, 2006

(51) Int. Cl. G01J 3/45; G02B 26/00

(52) U.S. Cl. 356/454; 359/290

(57) ABSTRACT

According to some embodiments, a micro-electrical mechanical system apparatus includes an actuator within a plane and at least one movable mirror oriented substantially normal to the plane. The actuator may move the movable mirror with respect to a fixed mirror oriented substantially normal to the plane and substantially parallel to the movable mirror. The space between the fixed and movable mirrors might comprise, for example, a Fabry-Perot filter cavity for a spectrometer.

### BACKGROUND

Devices may sense the presence (or absence) of particular molecules. For example, a miniature or hand-held spectrometer might be used to detect biological, chemical, and/or gas molecules. Such devices might be useful, for example, in the medical, pharmaceutical, and/or security fields. By way of example, a hand-held device might be provided to detect the presence of explosive materials at an airport.

In some sensing devices, light reflected from a sample of molecules is analyzed to determine whether or not a particular molecule is present. For example, the amount of light reflected at various wavelengths might be measured and compared to a known “signature” of values associated with that molecule. When the reflected light matches the signature, it can be determined that the sample includes that molecule.

In some sensing devices, a Fabry-Perot filter such as the one illustrated in FIG. 1 is used to analyze light reflected from a sample of molecules. The filter 100 includes a first partially reflecting mirror 110 and a second partially reflecting mirror 120 that define a resonant cavity C. Broadband light enters the filter 100, and some photons reflect off of the first mirror 110 while others pass through the mirror 110 and enter the cavity C. While in the cavity C, the photons bounce between the first and second mirrors 110, 120, and eventually some of the photons pass through the second mirror 120 and exit the filter 100.

As the photons bounce within the cavity C, interference occurs and an interference pattern is produced in light exiting the filter 100. As a result, light having a specific wavelength may exit the filter 100. Note that the interference occurring within the cavity C is associated with the distance d between the two mirrors 110, 120. Thus, the filter 100 may be “tuned” to output a particular wavelength of light by varying the distance d between the mirrors 110, 120 (e.g., by moving at least one of the mirrors 110, 120).

In some cases, one of the mirrors is formed using a diaphragm that can be flexed to change the distance d. For example, FIG. 2 is a side view of a Fabry-Perot filter 200 implemented using a flexible diaphragm mirror 210 and a fixed mirror 220. By measuring light reflected from a sample using various distances d (i.e., at various wavelengths), and comparing the results with a known signature of values, it may be determined whether or not a particular molecule is present in a sample. The diaphragm 210 might be flexed, for example, by applying a voltage difference between the mirrors 210, 220.

Such an approach, however, may have disadvantages. For example, the curving of the flexible diaphragm mirror 210 may limit its usefulness as a Fabry-Perot mirror. Moreover, the use of a flexible diaphragm mirror 210 may introduce stress over time and lead to failures. The design might also require bonding materials together that have different thermal characteristics—which can lead to problems at relatively high, low, or dynamic temperature environments. In addition, as the size of the cavity C is reduced, it can be difficult to efficiently control the movement of the flexible diaphragm mirror 210. Note that the use of piezoelectric elements to move mirrors arranged as in FIG. 2 can result in similar problems.

### SUMMARY

According to some embodiments, a micro-electrical mechanical system apparatus includes an actuator within a plane and at least one movable mirror oriented substantially normal to the plane. The actuator may move the movable mirror with respect to a fixed mirror oriented substantially normal to the plane and substantially parallel to the movable mirror. The space between the fixed and movable mirrors might comprise, for example, a Fabry-Perot filter cavity for a spectrometer.

Some embodiments comprise: means for routing light from a sample of molecules into a tunable Fabry-Perot cavity; means for scanning a first partially transmitting mirror of the cavity through a range of positions relative to a second partially transmitting mirror of the cavity, wherein the first and second mirrors are (i) substantially parallel to each other and (ii) substantially normal to a plane defined by a wafer, such as a silicon wafer; and means for detecting an interference pattern across a spectral range of light wavelengths, wherein different portions of the spectral range are associated with different distances between the first and second mirrors.

Other embodiments may provide a spectrometer having a laser source and an analyte sample to reflect light from the laser source. A Fabry-Perot filter cavity may be provided to receive the reflected light, including: an actuator within a plane; at least one movable mirror oriented substantially normal to the plane, wherein the actuator is to move the movable mirror; and a fixed mirror oriented substantially normal to the plane and substantially parallel to the movable mirror. In addition, a detector may be provided to detect photons exiting the Fabry-Perot filter cavity over time as the movable mirror is moved by the actuator. According to some embodiments, a decision unit may determine if the analyte sample is associated with at least one type of molecule based on the sensed photons.

### BRIEF DESCRIPTION OF THE DRAWINGS

FIG. 1 is a side view of a Fabry-Perot filter.

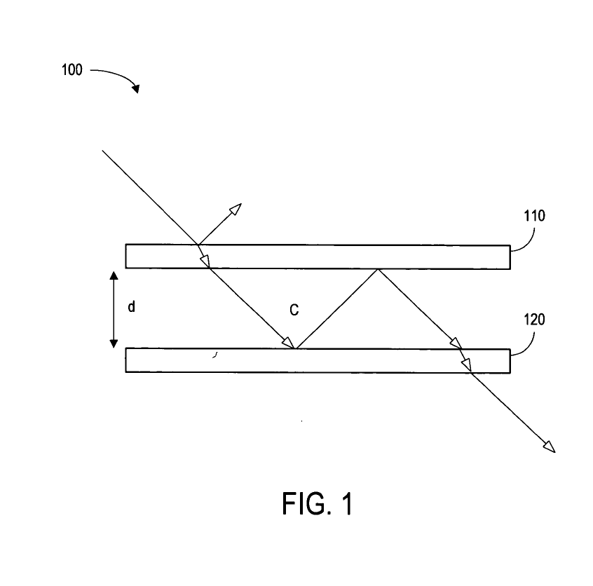

FIG. 2 is a side view of a Fabry-Perot filter implemented using a flexible diaphragm.

FIG. 3 is a side view of a Fabry-Perot filter in accordance with an exemplary embodiment of the invention.

FIG. 4 illustrates a spectrometer according to some embodiments.

FIG. 5 illustrates a method to analyze a sample of molecules according to some embodiments.

FIG. 6 is a top view of a Fabry-Perot filter having a comb drive in accordance with an exemplary embodiment of the invention.

FIG. 7 is a perspective view of a wafer associated with a Fabry-Perot filter in accordance with an exemplary embodiment of the invention.

FIG. 8 is a side view of a Fabry-Perot filter with unbalanced mirrors in accordance with an exemplary embodiment of the invention.

### DETAILED DESCRIPTION

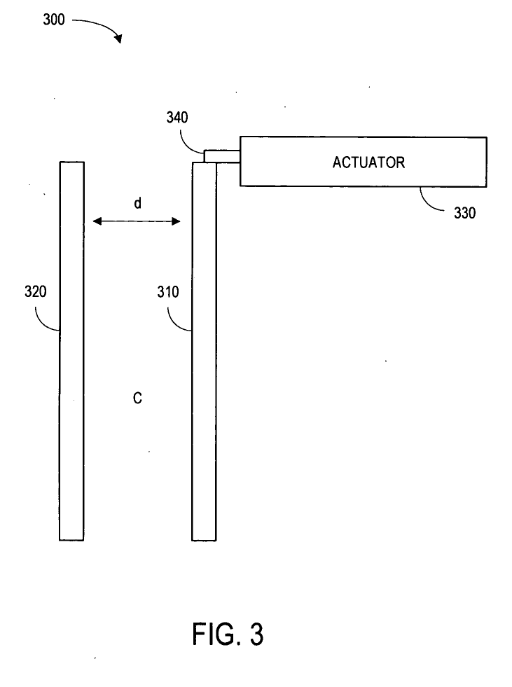

FIG. 3 is a side view of a Fabry-Perot filter 300 in accordance with an exemplary embodiment of the invention. The filter 300 includes a first partially reflecting mirror 310 and a second partially reflecting mirror 320 that define a resonant cavity C. According to this embodiment, the first mirror 310 acts as a movable mirror while the second mirror 320 is fixed. Note that the movable mirror 310 may be substantially parallel to the fixed mirror 320.

The filter 300 further includes an actuator 330 within a plane, such as a plane defined by a surface of a silicon wafer. Note that the movable and/or fixed mirrors 310, 320 may be oriented substantially normal to that plane (e.g., vertically within the wafer).

According to some embodiments, the actuator 330 is coupled to the movable mirror 310 via an attachment portion 340. Moreover, the actuator 330 may move or “scan” the movable mirror 310 left and right in FIG. 3 to vary distance d over time.

As the movable mirror 310 is scanned, broadband light may enter the filter 300 (e.g., via fiber optic cable introducing the light through the fixed mirror 320) and some photons may reflect off of the fixed mirror 310 while others pass through the mirror 310 and enter the cavity C. While in the cavity C, the photons may reflect between the fixed and movable mirrors 310, 320, and eventually some of the photons may pass through the movable mirror 320 and exit the filter 300.

As a result, the filter 300 may act as a narrow-band optical filter and the wavelength of light that exits the filter may vary over time (as d is varied). That is, the wavelength of light output from the filter 300 will scan back and forth across a range of the optical spectrum over time. By measuring the intensity of the light at various times (and, therefore, various distances d and wavelengths), information about the light entering the filter can be determined.

Although a single pair of mirrors 310, 320 are illustrated in FIG. 3, additional mirrors may be provided (e.g., to define multiple cavities). Moreover, although flat, rectangular mirrors 310, 330 are illustrated in FIG. 3 other configurations may be provided. For example, one or both of the mirrors 310, 320 might be curved. Similarly, one or both of the mirrors 310, 320 might be U-shaped or I-shaped.

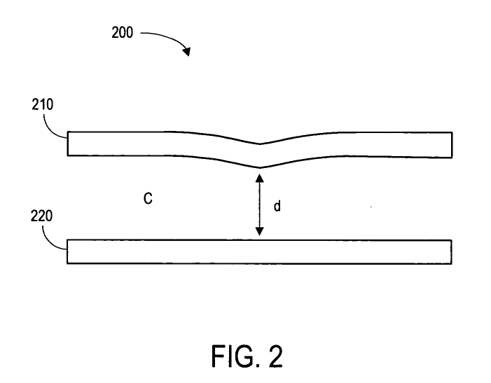

The actuator 330 may be any element capable of moving the movable mirror 310. Note that, unlike the flexible diaphragm approach described with respect to FIG. 2, the actuator 330 may be provided separate from the movable mirror 310. That is, the activation may be decoupled from the optics (e.g., the mirrors do not act as electrodes or movable membranes). As a result, the tunability of the filter 300 may be improved. In addition, the filter 300 may be scanned over longer distances and spatial (and therefore spectral) resolution may be increased. Also note that having the light enter the Fabry-Perot filter 300 via the fixed mirror 320 (as opposed to the movable mirror 310) may reduce stiction issues and prevent fluctuations in any gap between a fiber optic cable and the filter 300.

According to some embodiments, the actuator 330 may be a bi-stable structure. In this case, the actuator 330 may be snapped between the two stable positions to scan the filter 300. The actuator 330 might be associated with, for example, a thermal device, an electrostatic device, and/or a magnetic device. According to some embodiments, a spring may be coupled to the movable mirror 310 and/or actuator 330 to improve control.

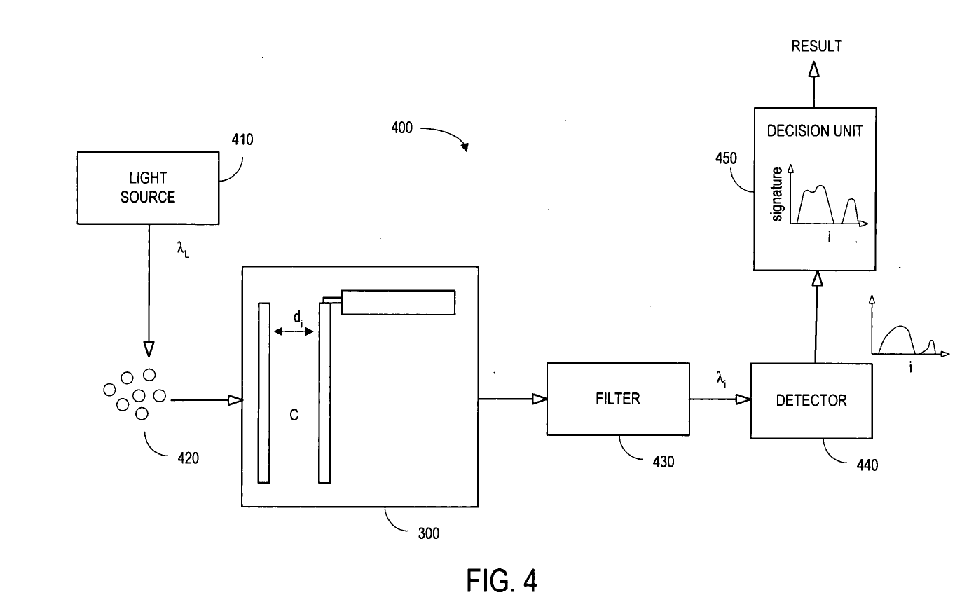

The Fabry-Perot filter 300 may be associated with, for example, a spectrometer. FIG. 4 illustrates a spectrometer 400 that might be associated with, for example, a Raman device, an infra-red absorption device, and/or a fluorescence spectroscopy device.

According to this embodiment, the spectrometer 400 includes a light source 410 (e.g., a laser associated with λ_{L}) that provides a beam of light to an analyte sample 420. Photons are reflected off of the analyte sample 420 and pass through the Fabry-Perot filter 300 as described, for example, with respect to FIG. 3. According to some embodiments, another filter 430 may also be provided (e.g., a Rayleigh filter to remove λ_{L}).

Because the Fabry-Perot filter 300 is scanning dᵢ over time, a detector 400 may measure light having varying wavelengths λ_{L} over time. These values may be provided to a decision unit 450 that compares the values with a signature of a known molecule (or sets of molecules) signatures. Based on the comparison, the decision unit 450 may output a result (e.g., indicating whether or not any of the signatures were detected).

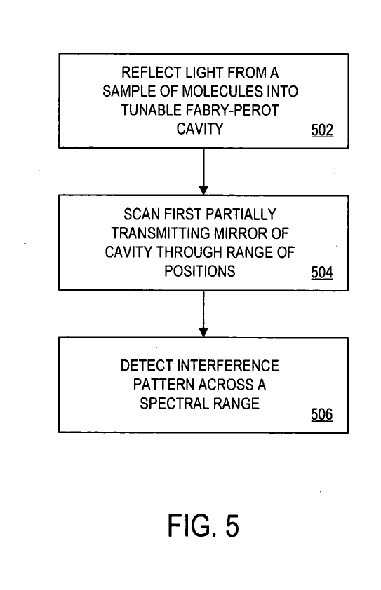

FIG. 5 illustrates a method to analyze a sample of molecules according to some embodiments. At Step 502, light is reflected from a sample of molecules into a tunable Fabry-Perot cavity.

At Step 504, a first partially transmitting mirror of the cavity is scanned through a range of positions relative to a second partially transmitting mirror of the cavity. According to some embodiments, the first and second mirrors are (i) substantially parallel to each other and (ii) substantially normal to a plane defined by a silicon wafer. Note that the scanning might be performed by an actuator within the plane defined by the silicon wafer.

At Step 506, an interference pattern is detected across a spectral range of light wavelengths. Note that different portions of the spectral range may be associated with different distances between the first and second mirrors. The detected interference pattern may then be compared with a signature pattern associated with a particular molecule, and an indication may be provided based on the comparison.

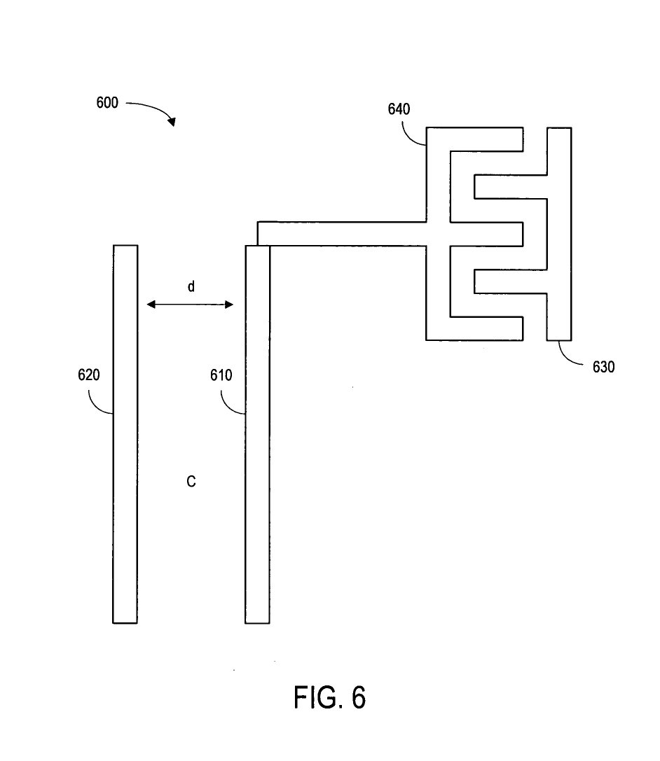

Note that different types of actuators may be used to move a movable mirror in a Fabry-Perot filter, including parallel plate drives and/or comb drives. FIG. 6 is a top view of a Fabry-Perot filter 600 having a comb drive in accordance with an exemplary embodiment of the invention. In this case, a movable mirror 610 may be moved with respect to a fixed mirror 620 by a first set of conducting portions or “fingers” 630 interlaced with a second set of conducting fingers 640. A varying voltage difference may be provided between the forgers 630, 640 causing the fingers 630, 640 to be pushed/pulled left or right in FIG. 6. Note that any number of fingers may be provided for a comb drive (and that any number of comb drives may be provided for a Fabry-Perot filter 600).

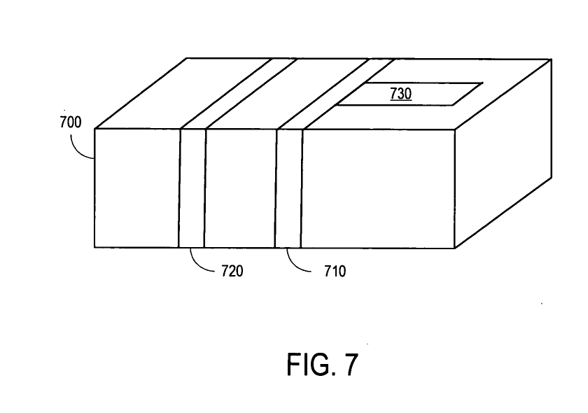

According to some embodiments, a movable or fixed mirror may be associated with a crystallographic plane of silicon and a Fabry-Perot filter may be associated with a Micro-electromechanical System (MEMS) device. For example, FIG. 7 is a perspective view of a wafer 700 that may be associated with a Fabry-Perot filter in accordance with an exemplary embodiment of the invention. In this case, portions of the wafer 700 may be etched away resulting in a pair of vertical mirrors 710, 720. Moreover, an actuation portion 730 may be etched onto the surface of the wafer 700 to move the movable mirror 710. Note that the vertical orientation of the mirrors 710, 720 might provide for taller, more thermally, mechanically, and optically stable structures as compared to horizontal ones. For example, a cavity 3 microns wide might be associated with mirrors having a height of 250 microns. Note that optical coating or Bragg reflectors (coating multi-layers and/or fine slots of air etched in the mirror wall) might be provided one or both mirrors 710, 720 to adjust reflection (and thereby increase resolution and contrast).

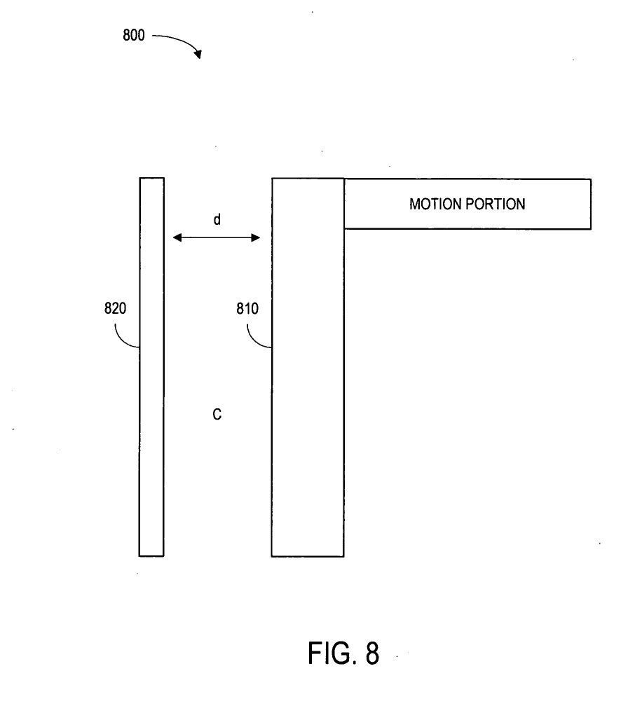

Although the mirrors 710, 720 illustrated in FIG. 7 have substantially the same thickness, an “unbalanced” mirror design might be provided. For example, FIG. 8 is a side view of a Fabry-Perot filter 800 with unbalanced mirrors in accordance with an exemplary embodiment of the invention. In this case, a movable mirror 810 may be substantially thicker than a fixed mirror 820. Such a design might, for example, increase the amount of light that is transmitted from the Fabry-Perot filter 800. Moreover, the movable mirror 810 might be less likely to flex or otherwise deform as it is scanned.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although a single movable mirror has been provided in some embodiments described herein, note that both mirrors associated with a Fabry-Perot cavity might be movable (and each mirror might be simultaneously moved with respect to the other mirror).

Further, although particular layouts and manufacturing techniques have been described herein, embodiments may be associated with other layouts and/or manufacturing techniques. For example, cap wafers with optical and/or electrical ports may be provided for any of the embodiments described herein. Such wafers may, for example, be used to interface with an Application Specific Integrated Circuit (ASIC) device.

Moreover, although Fabry-Perot filter designs have been described with respect to spectrometers, note that such filters may be used with any other types of devices, including telecommunication devices, meteorology devices, and/or pressure sensors.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A micro-electrical mechanical system apparatus, comprising:
an actuator within a plane of a wafer; and
at least one movable mirror oriented substantially normal to the plane of the wafer, wherein the actuator is to move the movable mirror.

2. The apparatus of claim 1, further comprising:
a fixed mirror oriented substantially normal to the plane and substantially parallel to the movable mirror.

3. The apparatus of claim 2, wherein the movable mirror is substantially thicker than the fixed mirror.

4. The apparatus of claim 2, wherein the space between the fixed and movable mirrors is a Fabry-Perot filter cavity.

5. The apparatus of claim 4, wherein the Fabry-Perot filter cavity is associated with a spectrometer.

6. The apparatus of claim 4, further comprising:
a light source.

7. The apparatus of claim 6, wherein the light source is broadband light scattered from an analyte sample.

8. The apparatus of claim 4, further comprising:
a sensor to sense photons exiting the Fabry-Perot filter cavity over time as the movable mirror is moved by the actuator.

9. The apparatus of claim 1, wherein the actuator is associated with a bi-stable structure.

10. The apparatus of claim 1, wherein the actuator is associated with at least one of: (i) a thermal device, (ii) an electrostatic device, or (iii) a magnetic device.

11. The apparatus of claim 10, wherein the actuator is an electrostatic device associated with at least one of: (i) a parallel plate drive or (ii) a comb drive.

12. The apparatus of claim 1, further comprising a spring coupled to the movable mirror.

13. The apparatus of claim 2, wherein at least one of the movable or fixed mirrors is curved.

14. The apparatus of claim 2, wherein at least one of the movable or fixed mirrors is associated with a crystallographic plane of silicon.

15. The apparatus of claim 2, wherein at least one of the movable or fixed mirrors is associated with at least one of: (i) a coating, (ii) a multi-layer coating, or (iii) a series of air slots parallel to the plane of the mirror for reflectance enhancement.

16. The apparatus of claim 1, wherein the apparatus is associated with at least one of: (i) a telecommunication device, (ii) a meteorology device, or (iii) a pressure sensor.

17. A method, comprising:
routing light from a sample of molecules into a tunable Fabry-Perot cavity;
scanning a first partially transmitting mirror of the cavity through a range of positions relative to a second partially transmitting mirror of the cavity, wherein the first and second mirrors are (i) substantially parallel to each other and (ii) substantially normal to a plane defined by a silicon wafer; and
detecting an interference pattern across a spectral range of light wavelengths, wherein different portions of the spectral range are associated with different distances between the first and second mirrors.

18. The method of claim 17, wherein said scanning is performed by an actuator within the plane defined by the silicon wafer.

19. The method of claim 17, further comprising:
comparing the detected interference pattern with a signature pattern associated with a particular molecule.

20. The method of claim 19, further comprising:
providing an indication based on said comparing.

21. A spectrometer, comprising:
a laser source;
an analyte sample to reflect light from the laser source;
a Fabry-Perot filter cavity to receive the reflected light, including
an actuator within a plane of a wafer,
at least one movable mirror oriented substantially normal to the plane of the wafer, wherein the actuator is to move the movable mirror, and
a fixed mirror oriented substantially normal to the plane and substantially parallel to the movable mirror;
a detector to detect photons exiting the Fabry-Perot filter cavity over time as the movable mirror is moved by the actuator; and
a decision unit to determine if the analyte sample is associated with at least one type of molecule based on the sensed photons.

22. The spectrometer of claim 21, wherein the spectrometer comprises at least one of (i) a Raman device, (ii) an infra-red absorption device, or (iii) or a fluorescence spectroscopy device.
